(19) United States
(12) Patent Application Publication
(10) Pub. No.: US 2004/0008287 A1
(43) Pub. Date: Jan. 15, 2004

(54) Combination handheld remote control unit and television receiver-transmitter

(76) Inventors: Shane Johnston, Rancho Santa Margarita, CA (US); Mark Johnston, Rancho Santa Margarita, CA (US); Camille Attell, Santa Ana, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/193,483

(22) Filed: Jul. 10, 2002

(51) Int. Cl. H04N 5/44

(52) U.S. Cl. 348/734

(57) ABSTRACT

A television receiver uses a remote control device, as is well known. The television receiver receives and processes more than one channel of information simultaneously. The receiver is enabled for transmitting one channel of this information using wave energy. The remote and receiver communicate using this wave energy so that the remote can select which channel is to be displayed on the receiver, but also so that the remote is able to direct the receiver to transmit a second channel of information to the remote where it is displayed. Therefore, the remote is able to scan and review alternate channel choices while viewing a previously selected channel on the receiver. When an alternate channel is desired, the remote may then direct the receiver to change channels.

### BACKGROUND OF THE INVENTION

INCORPORATION BY REFERENCE: Applicant(s) hereby incorporate herein by reference, any and all U.S. patents, U.S. patent applications, and other documents and printed matter cited or referred to in this application.

### FIELD OF THE INVENTION

This invention relates generally to controls for television sets, and more particularly to a remote control for a television set.

### DESCRIPTION OF RELATED ART

The following art defines the present state of this field:

Baker et al., U.S. Des. 424,060 describes a remote control unit design.

Ehlers, U.S. Pat. No. 4,626,848 describes a reconfigurable remote control transmitter that has the ability to learn, store and repeat the remote control codes from any other infrared transmitter. The reconfigurable remote control transmitter includes an infrared receiver, a microprocessor, nonvolatile and scratch pad random access memories, and an infrared transmitter. The microprocessor application is divided into four main categories: learning, storing, retransmitting, and user interface. In the learning process, the reconfigurable remote control transmitter receives and decodes the transmissions from another remote control transmitter. The process is repeated at least twice for each key to make sure that it has been properly received and decoded. Once the data has been received and decoded, it is stored for later use. In order to do this, the received and decoded data is compressed so that it can fit into the nonvolatile memory. This process is repeated for each of the several remote control transmitters that are to be replaced by the reconfigurable remote control transmitter. When the learning and storing operations have been completed, the reconfigurable remote control transmitter is ready to use.

Kohler, U.S. Pat. No. 4,712,105 describes a remote control hand apparatus for operating different modules such as a TV-receiver, teletext decoder, video recorder, VLP player, audio system, audio tuner, compact disc player, audio recorder, etc. This hand apparatus has a plurality of module keys by means of which the user can get access to a specific module. In addition, a dot-matrix display element is provided around which a plurality of multi-functional keys are arranged. The control function of such a key depends on the module key operated and this function is shown on the display-element for each of these keys.

Platte et al, U.S. Pat. No. 4,728,949 describes a remote control unit, particularly for a television receiver or a video tape recorder, having a limited number of keys which have different functions that are identified by lettering presented on display elements corresponding to the keys, depending upon which appliance is selected for control. The remote control unit employs a microprocessor, which cooperates with plug-in memories for the various appliances, the memories defining the key usages and corresponding lettering, etc. The remote control unit includes an additional display element for providing brief instructions to the user or displaying information received from the controlled appliance via a return channel.

Evans et al., U.S. Pat. No. 4,825,200 describes a reconfigurable remote control transmitter that can be used with a plurality of remotely controlled products, each of which is normally controlled with one or more signals from an associated remote control transmitter. The reconfigurable transmitter has a plurality of input keys and operates either in a Learn mode in which it may store indications of signals generated by the remote control transmitter from one or more of the products or a Run mode in which it selectively transmits stored signals in response to one or more keyed inputs. During the Learn mode a selected sequence of operations to be performed by one or more of the products in response to a first selected key sequence may be stored and during the Run mode stored signals are transmitted in a predetermined order in response to the performance of the selected key sequence to cause the selected sequence of operations to be performed. The transmitter may also include one or more timers settable to a selected data and time, which may be utilized to control the transmitting of stored signals or signal sequences. Finally, a means may be provided which is operative during the Learn mode for indicating that the signal being received by the transmitter from a remote transmitter is of proper strength to permit an indication thereof to be correctly stored.

Smith, U.S. Pat. No. 4,856,081 describes a reconfigurable remote control apparatus and method for capturing the signals of transmission devices of at least two different protocols. Because transmission devices either output signal bursts of different lengths at a carrier frequency followed by pauses of different lengths, or pulses of a relatively constant length followed by pauses of different lengths, a first determination is made as to the type of system being captured. After the system type is determined, the carrier frequency and the burst and pause lengths are determined for a burst type system, while only the pause lengths are determined for a pulse-pause type system. The captured information is preferably compressed according to a preferred compression scheme which finds and stores all possible signal lengths and all permitted adjacent signal length combinations for a particular apparatus, and composes and stores a compressed code which acts as a pointer to the stored signal length combinations. A further aspect of the invention is that a user need only press the keys of the remote unit to be captured during the capturing sequence and is prompted to do so by the apparatus of the invention.

Nelson, U.S. Pat. No. 5,710,605 describes a universal remote control unit for controlling a television and videocassette recorder including a data input mechanism securable to a telephone line for receiving signals from an external supplier representing television programing schedule items; a display mechanism for displaying television programing schedule items and television and videocassette operating functions in a hierarchy of textual and scrollable selection lists; a user-operable selector mechanism for allowing a user to scroll through the lists and then select television programing schedule items or television and videocassette functions; another user-operable selector mechanism for allowing a user to generate billing signals signifying a payment to be made in response to the receipt of the television programming schedule items from the external supplier; a data output mechanism securable to a telephone line for transmitting the billing signals representing a payment made to the external supplier; a processor mechanism for controlling operations; and a transmitter mechanism responsive to the processor mechanism for generating and transmitting via free space remote scheduling signals for subsequent receipt by the television and videocassette recorder for scheduling and controlling each of their operations.

Yoshinobu et al., U.S. Pat. No. 5,721,584 describes a two-way broadcasting system and a receiving system which can be realized at a low cost and is not required to newly connect the connecting cables and extended wiring layout. A multiplexed broadcast signal is transmitted from the broadcasting side under the condition that the two-way broadcast program information can be separated from the principal audio signal of the broadcast program and the two-way broadcast program information can be reproduced as the audible sound in the receiving side. In the receiving side, such broadcast signal is received and the reproduced voice signal including the two-way broadcast program information is reproduced from a loud speaker system. The two-way broadcast program information is extracted from the collected voice signal and is then decoded in a decoding means. Using this decoded information, the response information to the two-way broadcast program can be transmitted to the predetermined response-sending destination through the communication line.

Parvulescu et al., U.S. Pat. No. 5,802,460 describes a telephone handset and remote controller apparatus for transmitting information such as phone numbers and addresses for storing in a messaging device. The telephone handset and remote controller apparatus includes a housing and a plurality of actuators disposed on the housing for allowing information to be input into memory in the telephone handset and remote controller apparatus and to allow control of the operation of the telephone handset and remote controller apparatus. A radiofrequency transceiver included in the telephone handset and remote controller apparatus is responsive to the actuation of the actuators, and transmits a television control signal for controlling a television receiver in response to actuation of at least a first of the actuators, transmits a first radiofrequency signal for providing a radiofrequency communications link in response to actuation of at least a second of the actuators, and transmits to the messaging device, a second radiofrequency signal encoded with the information in response to actuation of at least a third of the actuators. The radiofrequency transceiver in the telephone handset and remote controller apparatus receives radiofrequency communication signals from an associated base station, and if the messaging device is bidirectional, also receives messaging signals from the messaging device. The telephone handset and remote controller apparatus may also have a data connector so that it may be connected to a computer in order to receive downloaded information such as software updates and the like and transmit such information to the messaging device.

Chiloyan et al., U.S. Pat. No. 6,008,735 describes a method and system for programming a remote control unit to control the operation of a controllable device. A group of code sets associated with a particular type and brand of controllable device are selected from a database of code sets stored in the memory of the remote control unit. The commands of each code set in the group of code sets are compared to identify similarities and dissimilarities between command formats within each respective code set. The user tests a command and provides feedback to the remote control unit regarding the results of such testing. When the testing of a command is successful, the remote control unit eliminates code sets containing a command format that is dissimilar to the format of the command that was successfully tested. By eliminating code sets from the group of code sets and testing other commands, the remote control unit eliminates all but one code set. The one remaining code set is identified as the best code set and is added to the remote control unit to allow the remote control unit to transmit signals to control operation of the controllable device.

Croy et al., U.S. Pat. No. 6,040,829 describes a hand-held device and system for monitoring and controlling electronic devices. In one embodiment, a control device for monitoring and controlling an electronic device, includes: 1) a base unit including a microcontroller and an interface coupled to the microcontroller for receiving external information; and 2) a personal navigator coupled to the base unit via a data link, the personal navigator further including a display component for displaying a dual partition selection list including at least a portion of the external information received from the interface, the dual partition selection list further includes a first selection list and a second selection list, at least a portion of the first selection list and at least a portion of the second selection list being at least partly concurrently displayable on the display component.

Platz, EP 1047034 A2 describes at least one transmission device located in a housing and at least one receiver unit located in a controlled equipment or device for the wireless transmission of the remote control instructions. A battery compartment provides a power supply. Control panel includes programmable control glass panel, which transfers switching signals to the transmission device on application of pressure, and includes thin glass disk and carrier material, which are separated by spacers, which facilitate contact on application of pressure. An LCD indicating display is included to verify functional fields, which display information on the glass panel. The electrically conductive layer touches the glass disk when pressure is applied to a point. The thin glass disk has light scattering surface, sound transducer and light guide ribbon with prismatic surface. Glass panel also has an illumination device. Encoded signals are transferred by wireless, and infrared transmission.

The prior art teaches remote control devices that are reconfigurable, programmable, that control plural devices, that control various functions, that have a display with choices displayed, that are part of a two-way broadcasting system, that are part of a telephone, that provide for complex programming, and that are part of a navigation system, but does not teach a remote control device that remotely controls the transmission of information from a television receiver for reception and display by the remote control device. The present invention fulfills these needs and provides further related advantages as described in the following summary.

### SUMMARY OF THE INVENTION

The present invention teaches certain benefits in construction and use which give rise to the objectives described below.

A television receiver uses a remote control device, as is well known. The television receiver receives and processes more than one channel of information simultaneously. The receiver is enabled for transmitting one channel of this information using wave energy. The remote and receiver communicate using this wave energy so that the remote can select which channel is to be displayed on the receiver, but also so that the remote is able to direct the receiver to transmit a second channel of information to the remote where it is displayed. Therefore, the remote is able to scan and review alternate channel choices while viewing a previously selected channel on the receiver. When an alternate channel is desired, the remote may then direct the receiver to change channels.

A primary objective of the present invention is to provide an apparatus and method of use of such apparatus that provides advantages not taught by the prior art.

Another objective is to provide such an invention capable of remotely changing channels in a television receiver.

A further objective is to provide such an invention capable of viewing alternate channels at the remote control device while simultaneously displaying a selected channel on the receiver.

A still further objective is to provide such an invention capable of playing a selected channel on both receiver and remote simultaneously.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawing illustrates the present invention. In such drawing:

FIG. 1 is a perspective view of the preferred embodiment of the invention.

### DETAILED DESCRIPTION OF THE INVENTION

The above described drawing figures illustrate the invention in at least one of its preferred embodiments, which is further defined in detail in the following description.

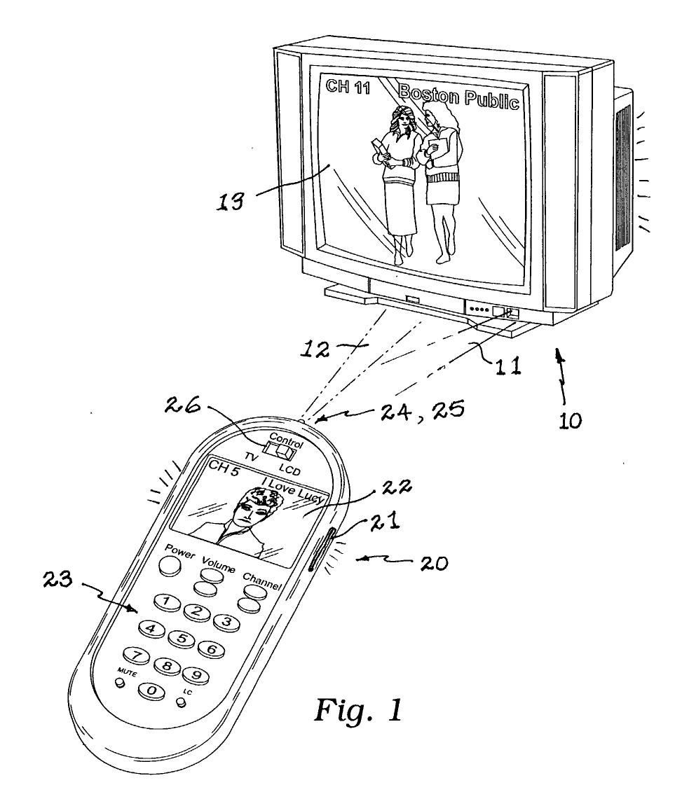

The present invention is a television receiver 10 and remote control device 20 combination. The receiver 10 is adapted for receiving and processes more than one channel of television information simultaneously. This type of device is well known in the television industry as is the case for the well known picture-in-picture technology. Likewise, the receiver 10 of the present invention uses identical technology to receive and process plural channels of television information simultaneously. What this incurs is to draw down and tune plural of the television signals that arrive at the antenna or on a cable, at the same time. In effect, the present invention need only tune two television signals at any one time and the technology to accomplish this is in general use by the public. The receiver 10 is also enabled for transmitting one channel of this information using a wave energy such as radio waves, infrared light energy waves or other optical, microwave or other wave energy regimes. See item 11 in FIG. 1. Such transmission is, of course, well known, as it is used for general television broadcasting but in this case it is preferably in the form of IR wave energy. The remote 20 and receiver 10 communicate using this wave energy so that the remote 20 can select a channel is to be displayed on the receiver 10, and this is in common usage in most receivers 10 today. See item 12 in FIG. 1. Also the remote 20 is able to direct the receiver 10 to transmit a second channel of information to the remote 20 where it is displayed on a display device 22 as shown in FIG. 1. The first channel of information being displayed on the receiver display 13. Clearly, it is well known in the art how to take a television channel information and place it into a form for display and audio production on a receiver 10. This is the same method used to display a selected channel of information transmitted from the receiver to the remote 20 for display thereupon. The remote 20 processes only one channel of information at one time and displays it on display 22 and renders corresponding audio information through miniature speaker 21. Therefore, the remote is able to scan and review alternate channel choices, one at a time, while a user continues to view a previously selected channel on the receiver 10. When an alternate channel is desired, the remote 20 may then direct the receiver 10 to change channels for viewing the alternate channel on the receiver 10. The same keypad is used to direct channel selection on the receiver and on the remote by using the selector switch 26. The remote 20 may be used to view the same channel of information presented on the receiver 20 for those who are hard of hearing or nearsighted or too far from the receiver 10 for comfortable viewing and listening. It is considered to be a routine act to enable the present invention, and it is not in its working details that the appended claims are based, but rather it is based on the relationship in operation between the receiver 10 and the remote 20, especially that the remote 20 is enabled for directing the receiver 10 to continuously transmit a selected channel to the remote 20 and also that the remote is able to display such channel. This relationship is not shown in the prior art and is thus novel and distinct.

It is considered obvious to make remote selections and transmit such selection to a television receiver using wireless technique, for displaying the selection on the receiver 10. It is also considered to be obvious to one of skill in the art to transmit information over short distances using wireless technique. It is also considered obvious to display information on small and hand-held devices such as the remote 20. It is not considered obvious to use a hand-held remote control device to direct a television receiver to transmit back to the remote 20 selected channel information that has been tuned and prepared for viewing by the receiver 10. It is not considered to be obvious to use a television receiver 10 to display one channel of information while transmitting a second channel of information to a remote control 20 having the ability to display such and to do so under the control of both channel displays by the remote control 20. Clearly, the present invention is applicable to other remotely operated systems such as hi-fidelity music systems, computer systems, etc.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A combination apparatus comprising: a television receiver and a remote control device; wherein the television receiver comprises plural television channel signal receiving and processing means, first wave energy transmitting means and first wave energy receiving means; and wherein the remote control device comprises a remote displaying means, remote selecting means, second wave energy receiving means and second wave energy transmitting means; the first wave energy transmitting means responsive to a signal from the remote control device for selecting one of the plural television channel signals received at the television receiver and enabled for sending the selected one of the plural television channel signals to the remote control device; the remote control device adapted for displaying the selected one of the channels received from the receiver on the remote displaying means simultaneously with the television receiver displaying a further one of the plural channels on the receiver displaying means as further selected by the remote control device.

2. A combination apparatus comprising: a television receiver and a remote control device; wherein the television receiver comprises plural television channel signal receiving and processing means, first wave energy transmitting means and first wave energy receiving means; and wherein the remote control device comprises a remote displaying means, remote selecting means, second wave energy receiving means and second wave energy transmitting means; the first wave energy transmitting means responsive to a signal from the remote control device for selecting one of the plural television channel signals received at the television receiver, the receiver enabled for sending the selected one of the plural television channel signals to the remote control device; the remote control device adapted for displaying the selected one of the channels received from the receiver on the remote displaying means simultaneously with the television receiver displaying one of the plural channels on the receiver displaying means.

3. A televiewing method comprising the steps of: receiving and processing plural television channel signals at a television receiver; transmitting a first channel choice selection to the receiver from a remote control device; displaying the first channel on the receiver; transmitting a second channel choice selection to the receiver from the remote control device; transmitting information contained in the second channel to the remote control device; and displaying the second channel information on the remote control device.

4. The method of claim 3 wherein the first and second channel choices are identical.
